(19) United States
(12) Patent Application Publication
(10) Pub. No.: US 2022/0236128 A1
(43) Pub. Date: Jul. 28, 2022

(54) PRESSURE SENSOR COMPONENTS HAVING MICROFLUIDIC CHANNELS

(71) Applicant: Honeywell International Inc., Charlotte, NC (US)

(72) Inventors: Palani Thanigachalam, Bengaluru (IN); Lokesha Bhat, Bengaluru (IN)

(21) Appl. No.: 17/248,489

(22) Filed: Jan. 27, 2021

(51) Int. Cl. G01L 9/00

(52) U.S. Cl. CPC G01L 9/0002

(57) ABSTRACT

Methods, apparatuses and systems for providing pressure sensing components for apparatuses are disclosed herein. An example pressure sensing component may comprise: a pressure sensing element defining a microfluidic channel containing a pressure transfer fluid configured to absorb a pressure of a media applied to the pressure sensing element, wherein at least one dimension of the microfluidic channel is in a micrometer range; and a pressure measuring element in electronic communication with the pressure sensing element, wherein the pressure measuring element is configured to convert a pressure of a media absorbed by the pressure sensing element into a measurable electrical signal.

### BACKGROUND

Apparatuses comprising pressure sensing components may detect and/or measure pressure in a wide variety of applications including, for example, commercial, automotive, aerospace, industrial, and medical applications. Many pressure sensing components are plagued by technical challenges and limitations. Through applied effort, ingenuity, and innovation, many of these identified problems have been solved by developing solutions that are included in embodiments of the present disclosure, many examples of which are described in detail herein.

### BRIEF SUMMARY

Various embodiments described herein relate to pressure sensing components in a variety of methods, apparatuses, and systems.

In accordance with various examples of the present disclosure, a pressure sensing component is provided. In some examples, the pressure sensing component comprises: a pressure sensing element defining a microfluidic channel containing a pressure transfer fluid configured to absorb a pressure of a media applied to the pressure sensing element, wherein at least one dimension of the microfluidic channel is in a micrometer range; and a pressure measuring element in electronic communication with the pressure sensing element, wherein the pressure measuring element is configured to convert the pressure of the media absorbed by the pressure sensing element into a measurable electrical signal.

In accordance with various examples of the present disclosure, a method for detecting a pressure of a media by a pressure sensing component comprising a microfluidic channel containing a pressure transfer fluid, wherein at least one dimension of the microfluidic channel is in a micrometer range is provided. The method may comprise absorbing, by the pressure sensing component, a pressure of a media; and converting, by the pressure sensing component, the pressure of the media into a measurable electrical signal.

The foregoing illustrative summary, as well as other exemplary objectives and/or advantages of the disclosure, and the manner in which the same are accomplished, are further explained in the following detailed description and its accompanying drawings.

### BRIEF DESCRIPTION OF THE DRAWINGS

The description of the illustrative embodiments may be read in conjunction with the accompanying figures. It will be appreciated that, for simplicity and clarity of illustration, elements illustrated in the figures have not necessarily been drawn to scale, unless described otherwise. For example, the dimensions of some of the elements may be exaggerated relative to other elements, unless described otherwise. Embodiments incorporating teachings of the present disclosure are shown and described with respect to the figures presented herein, in which:

FIG. 1 illustrates an example pressure sensing component in accordance with various embodiments of the present disclosure;

FIG. 2 illustrates a cross section view of an example pressure sensing component in accordance with various embodiments of the present disclosure;

FIG. 3 illustrates a cross section view of another example pressure sensing component in accordance with various embodiments of the present disclosure;

FIG. 3 illustrates an example controller component in accordance with various embodiments of the present disclosure; and

FIG. 5 illustrates an example method in accordance with various embodiments of the present disclosure.

### DETAILED DESCRIPTION OF THE INVENTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

The components illustrated in the figures represent components that may or may not be present in various embodiments of the present disclosure described herein such that embodiments may include fewer or more components than those shown in the figures while not departing from the scope of the present disclosure. Some components may be omitted from one or more figures or shown in dashed line for visibility of the underlying components.

The phrases “in an example embodiment,” “some embodiments,” “various embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such components or features may be optionally included in some embodiments, or may be excluded.

The term “electronically coupled” or “in electronic communication with” in the present disclosure refer to two or more electrical elements and/or electric circuit(s) being connected through wired means (for example but not limited to, conductive wires or traces) and/or wireless means (for example but not limited to, wireless network, electromagnetic field), such that data and/or information (for example, electronic indications, signals) may be transmitted to and/or received from the electrical elements and/or electric circuit(s) that are electronically coupled.

The term “pressure” may refer to a force applied perpendicular to a surface of an object per unit area over which the force is distributed. Gauge pressure may refer to a measure of pressure relative to an ambient pressure (e.g., atmospheric pressure). Absolute pressure may refer to a summation of gauge pressure and atmospheric pressure. In some examples, an example pressure sensing component may be configured to detect an absolute pressure, where a pressure of fluid in a channel is referenced against a vacuum pressure or other reference pressure. Pressure may be expressed using a number of different units (e.g., pascal (Pa), newton per square metre (N/m²), pound-force per square inch (psi), atmospheric pressure (atm) and the like). Pressure can be expressed in accordance with the following equation:

$$p = \frac{F}{A}$$

Where:

p=pressure;

F=the magnitude of the force; and

A=surface area on contact.

The term “microfluidic(s)” may refer to the control of fluids in small scale (e.g., sub-millimeter) systems in which at least one dimension of the system is in a micrometer range or below. In microfluidic systems, the flow of fluids may be laminar such that transportation of the fluid occurs through diffusion. In various applications, microfluidic systems may be used to process (e.g., transport, separate, mix and/or the like) small volumes of fluids (e.g., nanoliters or less) in various applications including automation, screening and communications. A microfluidic channel may define one or more paths used to store and/or convey a fluid from one location to another within an example microfluidic system. In some examples, a microfluidic channel may have a width between 25 and 600 micrometers and a depth of approximately 17 micrometers. Microfluidic channels and systems may be fabricated using techniques including soft lithography, hot embossing, injection molding, micro-machining, etching, 3D printing and/or the like.

Pressure sensing components are critical for a wide range of existing and emerging applications such as smart medical devices and real-time healthcare monitoring. Apparatuses and systems incorporating such pressure sensing components include, for example, without limitation motor control apparatuses, HVAC systems, hydraulic control systems, blood diffusion apparatuses, agricultural spraying apparatuses, compressors, robotics, automotive systems, control systems and the like. In some examples, such apparatuses may be configured to detect a pressure associated with a media (e.g., a substance, wet media, fluid and/or the like). For example, an example pressure sensing component may comprise a pressure sensing element and a pressure measuring element. The pressure sensing element may be configured to absorb a pressure of a media which in turn is detected and/or sensed by the pressure measuring element which is configured to convert an incoming pressure of the media (i.e., mechanical stress caused by the incoming pressure of the media) into a measurable electrical signal. In some applications, the pressure measuring element may be isolated from the media. This may be accomplished by providing a pressure transfer fluid (e.g., an oil) between a substrate (e.g., a diaphragm) of the pressure sensing element and the pressure measuring element. In some embodiments, pressure from the media may be applied to the example substrate (e.g., diaphragm) and subsequently absorbed by the pressure transfer fluid such that it can be detected and/or measured by the pressure measuring element. Such media-isolated pressure sensing components may be ideal for use in harsh environments as they are able to withstand exposure to harsh and/or corrosive media and substances (e.g., chemicals, gases and/or the like) and can operate within a wide range of environmental conditions. While such configurations may help isolate and protect the pressure sensing element from the media, they may be expensive to build, and may feature relatively high-offset variations in performance due to temperature changes. For instance, an example cavity containing an example pressure transfer fluid may exhibit relatively high aspect ratios (e.g., height-to-width or high volume) which must be carefully calibrated in order to generate accurate readings.

Apparatuses that comprise oil-filled pressure sensing components (e.g., silicon-based pressure sensing components) are plagued by challenges in measurement performance and reliability due to a variety of different factors. In some examples, a silicon-based pressure sensing component may be a media-isolated type as described above, i.e., may comprise an isolated substrate (e.g., diaphragm), a pressure measuring element (e.g., silicon chip) and a pressure transfer fluid disposed therebetween. In response to a pressure of a media, the substrate (e.g., diaphragm) of the pressure sensing component flexes such that the pressure is detected by the pressure measuring element (e.g., silicon chip) via the pressure transfer fluid. The pressure transfer fluid may be or comprise a relatively high volume of oil (e.g., 130 mm³ and above) disposed within a cavity or channel of the pressure sensing component. The volume of oil in such configurations may cause various technical problems and difficulties.

In some embodiments, air may penetrate the structure of a pressure sensing element and/or pressure sensing component and become trapped therein. For example, air may penetrate a cavity containing pressure transfer fluid, causing the pressure sensing element and/or pressure sensing component to malfunction.

In another example, as the operating temperature of the pressure sensing element and/or pressure sensing component fluctuates, the physical properties of the pressure transfer fluid may also change. For example, the physical properties of an oil may change as the air within it expands or contracts, resulting in measurement errors. Over time, as the pressure sensing component becomes less airtight, more air may penetrate the structure of the pressure sensing element and/or pressure sensing component thereby worsening the problem and leading to inaccurate measurements being generated by the pressure measuring component. In some cases, air may penetrate the structure of a pressure sensing element and/or pressure sensing component during manufacturing or fabrication.

As a result of thermal expansion and non-pressure effects attributable to oil in an example pressure sensing component, the overall performance and thermal stability of the pressure sensing component is affected which may result in inaccurate readings generated by apparatuses incorporating such pressure sensing components.

In accordance with various embodiments of the present disclosure, example methods, components, apparatuses, and systems are provided.

In various embodiments, the present disclosure may provide a mechanically-sealed pressure sensing component comprising a microfluidic channel containing a pressure transfer fluid. Utilizing microfluidic channels in the example pressure sensing component results in a drastic reduction in the volume of pressure transfer fluid (e.g., oil) required in such pressure sensing components. Further, microfluidic channels may facilitate the use of non-traditional oils (e.g., food-grade oils, light oils and the like) in such applications. Additionally, there is a reduction of available surface area for air to penetrate the example pressure sensing component. Further, with the reduced pressure transfer fluid volume, the effects of temperature fluctuations on the pressure transfer fluid (e.g., oil) are also greatly reduced. As a result, the example pressure sensing components exhibit reliable measurement performance and improved thermal stability. For example, with reduced surface area for air penetration, negative effects attributable to air entry during manufacturing and the operational life of the pressure sensing components are greatly reduced. Due to the small volume of pressure transfer fluid, sensitivity of the pressure sensing component is significantly improved (e.g., below 1 bar or 14.5037738 psi). Additionally, the example pressure sensing component can provide accurate measurements within a wide temperature range (e.g., between −40° C. and 120° C.).

In various embodiments, the present disclosure may provide a pressure sensing component comprising a pressure sensing element defining a microfluidic channel containing a pressure transfer fluid configured to absorb a pressure of a media applied to the pressure sensing element, wherein at least one dimension of the microfluidic channel is in a micrometer range. The pressure sensing component may comprise a pressure measuring element in electronic communication with the pressure sensing element. The pressure measuring element may be configured to convert the pressure of the media absorbed by the pressure sensing element into a measurable electrical signal. The pressure measuring element may be isolated from the pressure sensing element. The pressure measuring element may comprise a sensor in electronic communication with a printed circuit board assembly. The pressure measuring element may further be configured to, in response to receiving a control signal, generate a pressure indication corresponding with the measurable electrical signal, and transmit the pressure indication to a controller component in electronic communication with the pressure sensing component. The example sensor may comprise a sense die. A volume of pressure transfer fluid within the microfluidic channel may be between 6 mm³ and 18 mm³. The pressure transfer fluid may comprise silicon oil. The pressure transfer fluid may comprise a food-grade oil or light oil. The microfluidic channel may be mechanically and/or hermetically sealed. The microfluidic channel may define a cavity comprising a depth between 50-60 microns.

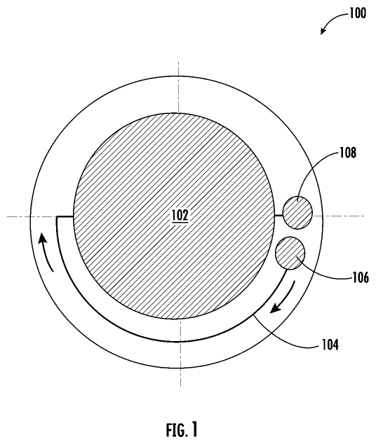

Referring now to FIG. 1, a top view of an example pressure sensing component 100 in accordance with various embodiments of the present disclosure is depicted. The example pressure sensing component 100 comprises a pressure sensing element 102 configured to detect a pressure of a media and a pressure measuring element configured to provide a measurable electrical signal in response to the media pressure absorbed by the pressure sensing element 102. The example pressure sensing component 100 may be configured to detect a pressure between 0 and 150,000 psi. As depicted, the example pressure sensing component 100 comprises a substantially planar, circular unitary body. For example, the pressure sensing component 100 may have a diameter of 10 mm and a thickness dimension of 5 mm.

As depicted in FIG. 1, the pressure sensing component 100 comprises a pressure sensing element 102 configured to absorb a pressure of a media. In various embodiments, at least a surface of the pressure sensing element 102 may be fixedly attached or coupled to one or more other elements of the pressure sensing component 100. In some examples, as shown, the pressure sensing element 102 comprises a substrate (e.g., diaphragm, membrane and/or the like) or layer of the pressure sensing component 100. In some examples, the substrate of the pressure sensing element 102 may be configured to deform in response to detecting the pressure of the media. In some examples, the substrate of the pressure sensing element 102 may comprise a metal (e.g., stainless steel) or other material.

As depicted in FIG. 1, the pressure sensing component 100 comprises a microfluidic channel 104. In various embodiments, the microfluidic channel 104 may be entirely disposed within the pressure sensing component 100. In some examples, the microfluidic channel 104 of the pressure sensing element 102 comprises a sealed cavity or channel containing a pressure transfer fluid (e.g., silicon oil or the like) which is configured to absorb a pressure applied to the substrate of the pressure sensing element 102. As depicted, the example microfluidic channel 104 comprises a fluid inlet 106 and a fluid outlet 108 defining a channel containing a pressure transfer fluid. The fluid inlet 106 and the fluid outlet 108 may be hermetically and/or mechanically sealed. In some embodiments, the microfluid channel 104 defines a path along which a pressure transfer fluid can be stored and/or conveyed within the pressure sensing component 100. In various embodiments, the microfluidic channel 104 is configured to transfer the pressure applied to and absorbed by the substrate of the pressure sensing element 102 such that it can be detected and measured by a pressure measuring element. In some cases, subsequent to conveying the pressure transfer fluid along the microfluidic channel 104, when pressure is no longer applied and/or detected, the pressure transfer fluid within the microfluidic channel 104 may flow in the opposite direction from the fluid outlet 108 to the fluid inlet 106. In various embodiments, the pressure transfer fluid may be transported by capillary forces and/or capillary actions acting thereon within the example microfluidic channel 104.

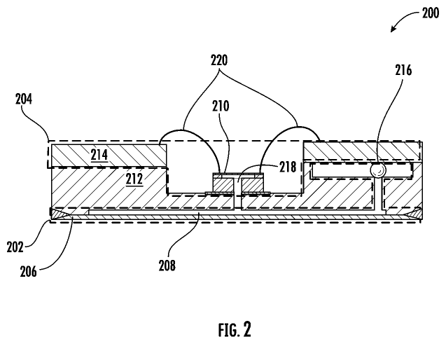

Referring now to FIG. 2, a cross-section of an example pressure sensing component 200 in accordance with various embodiments of the present disclosure is depicted. In particular, the example pressure sensing component 200 comprises a pressure sensing element 202 configured to detect a pressure of a media and a pressure measuring element 204 configured to provide a measurable electrical signal in response to the media pressure detected by the pressure sensing element 202. For example, as depicted, the pressure sensing component 200 comprises a substantially planar, circular unitary body. The example pressure sensing component 200 comprises a pressure sensing element 202 and a pressure measuring element 204 with an inner substrate 212 disposed therebetween. In some examples, the pressure sensing component 200 may have a diameter of 10 mm and a thickness dimension of 5 mm.

As depicted in FIG. 2, the pressure sensing element 202 comprises a outer substrate 206 defining a bottom surface of the pressure sensing component 200 configured to absorb a pressure of a media and an inner surface defining a microfluidic channel 208. As depicted, the outer substrate 206 comprises a diaphragm, membrane and/or the like configured to absorb the pressure of the media. As noted above, in some examples, the outer substrate 206 may be configured to deform in response to the pressure of the media. As depicted, the outer substrate 206 comprises a substantially planar, circular shape. In some examples, the outer substrate 206 may be or comprise stainless steel or other suitable material. By way of example, the diameter of the outer substrate 206 may be between 8 mm and 10 mm and the thickness dimension of the outer substrate 206 may be between 0.025 mm and 0.050 mm. As depicted in FIG. 2, the outer substrate 206 may be fixedly attached (e.g., welded) to a surface of the pressure sensing component 200, such as to another substrate or layer of the pressure sensing component 200. As depicted, the in FIG. 2, an inner surface of the outer substrate 206 is fixedly attached or welded to a surface of an inner substrate 212.

As depicted in FIG. 2, the pressure sensing element 202 comprises an inner substrate 212 disposed in between the outer substrate 206 and the pressure measuring element 204. In some examples, the diameter of the example inner substrate 212 may be approximately 10 mm and the thickness dimension of the example inner substrate may be 4 mm. For example, the inner substrate 212 may comprise a header (e.g., Kovar header). As depicted, the inner substrate 212 and the outer substrate 206 may be fixedly attached (e.g., welded) to one another. In some examples, the inner substrate 212 may be made from other materials such as stainless steel. Additionally, as depicted, a surface of the inner substrate 212 is fixedly attached to the pressure measuring element 204. As shown, the inner substrate 212 further comprises a concentrically located cavity (e.g., a 4 mm cavity) within which at least a portion of the pressure measuring element 204 is disposed within the pressure sensing component 200.

As depicted in FIG. 2, the pressure sensing element 202 comprises a microfluidic channel 208. The microfluidic channel 208 may be or comprise a sealed cavity or channel containing a pressure transfer fluid configured to absorb a pressure applied to the bottom surface of the outer substrate 206 such that it can be detected and measured by the pressure measuring element 204. In various examples, the example microfluidic channel 208 may be mechanically and/or hermetically sealed. By way of example, the microfluidic channel 208 may define a sealed 50-60 micron cavity containing a pressure transfer fluid. In some examples, the example microfluidic channel 208 may have a length of 3.5 mm and a height of 0.15 mm. For example, the volume of the pressure transfer fluid within the microfluidic channel 208 may be between 6 mm³ and 18 mm³. The microfluidic channel 208 may be sealed using one or more ball, screw or other materials and techniques. As depicted, the microfluidic channel 208 may be sealed using at least one ball 216 to close a first end of the microfluidic channel 208. In some examples, the microfluidic channel 208 may contain a pressure transfer fluid such as silicon oil. In some examples, the microfluidic channel 208 may contain other types of pressure transfer fluids, including, but not limited to, food-grade oils, light oil and/or the like. The use of food-grade and/or light oils provides a pressure transfer fluid with higher viscosity thereby increasing the sensitivity of the pressure sensing component and may shorten required manufacturing time and complexity. By way of example, the pressure transfer fluid may be olive oil. In response to a pressure applied to and absorbed by the outer substrate 206, the example pressure transfer fluid within the microfluidic channel 208 may absorb the pressure such that it can be detected by the pressure measuring element. In some embodiments, the pressure transfer fluid may be transported within the microfluidic channel 208. In some examples, in response to the pressure applied to the outer substrate 206, the fluid within the microfluidic channel may move from a first portion of the microfluidic channel 208 to a second portion of the microfluidic channel 208.

As noted above, the example pressure sensing component 200 comprises a pressure measuring element 204 configured to provide a measurable electrical signal in response to the media pressure detected and/or absorbed by the pressure sensing element 202. As depicted, the pressure measuring element 204 comprises a printed circuit board assembly (PCBA) 214 and a sensor 210. In various embodiments, the PCBA may be in electronic communication with the sensor 210 such that they can exchange data/information with one another.

As depicted in FIG. 2, a bottom surface of the sensor 210 may be fixedly attached or mounted on a surface of the inner substrate 212 such that the sensor 210 is able to detect a pressure transferred from an outer surface of the outer substrate 206 to the microfluidic channel 208. In some examples, as shown, the sensor 210 comprises a gap 218 (e.g., a 150 micron hole or gap) partially disposed within the sensor 210 and defining a channel between the sensor 210 and the microfluidic channel 208. The example sensor 210 may be or comprise a silicon die, piezoelectric chip, and/or the like. By way of example, the sensor 210 may be a silicon die mounted on a surface of the inner substrate 212 (e.g., Kovar header). The example sensor 210 (e.g., silicon die) may comprise a plurality of strain gauges in electronic communication with the PCBA 214. The sensor 210 may be electrically connected to the PCBA 214 using various techniques. In some examples, as depicted, wire bonds 220 may be utilized to electrically connect the sensor 210 to the PCBA 214. Additionally or alternatively, the sensor 210 may be electrically connected to the PCBA 214 via bump bonds and/or in any other suitable manner.

In some examples, the sensor 210 may comprise a micro-machined pressure sense die that includes a sense diaphragm. In some embodiments, the pressure sense die may be secured directly to the PCBA 214 and/or through various other means. The example micro-machined pressure sense die of the sensor 210 may have any size or shape. In some examples, the example sensor 210 (e.g., pressure sense die) may have a thickness between about 200 microns and about 800 microns and a surface area between about 10,000 microns² and about 4,000,000 microns². In some examples, the pressure sense die may have a thickness dimension between about 380 microns and about 410 microns and a surface area between about 200,000 microns² and about 500,000 microns². In one example, the pressure sense die may have a thickness dimension of about 390 microns and a surface area of about 390,625 microns² (e.g., when the pressure sense die is rectangular or square, the pressure sense die may have edges of about 625 microns in length). In various embodiments, the pressure sense die of the sensor 210 may be configured to detect a gauge pressure. Additionally and/or alternatively, the pressure sense die of the sensor 210 may be configured to detect an absolute pressure, where a pressure of fluid in the microfluidic channel 208 is referenced against a vacuum pressure or other reference pressure. In some examples, when sensing an absolute pressure, the sensor 210 may be fabricated to include a vacuum or reference cavity immediately behind a sense diaphragm, such that a pressure of fluid in the microfluidic channel 208 is referenced against a vacuum or other reference pressure.

As noted above, as depicted in FIG. 2, the pressure measuring element 204 comprises a PCBA 214 defining an upper surface of the pressure sensing component 200. The example PCBA 214 may comprise a thick film printed ceramic board, an FR 4 laminate and/or other material. The example PCBA 214 may comprise one or more electronic components thereon and/or pads for connecting to other electronic components of an apparatus in which the pressure sensing component 200 may be housed or with which the pressure sensing component 200 may be used. In some examples, the PCBA 1214 may include an application specific integrated circuit (ASIC) that may be attached to a surface of the PCBA 214, such as an ASIC electrically coupled to the PCBA 214 via wire bonds, bump bonds, electrical terminals, and/or any other suitable electrical connections. Additionally or alternatively, the example PCBA 214 may include one or more conductive pads for engaging circuitry and/or electronic components in communication with a processor, remote processor or the like.

Additionally and/or alternatively, the PCBA 214 may comprise one or more processing electronics and/or compensation circuitry (e.g., which may or may not include an ASIC). Such processing electronics may be electrically connected to terminals of the sensor 210, an ASIC (if present), and/or electrical terminals to process electrical signals from the sensor 210 and/or to transfer outputs from the sensor 210 to electronic components of one or more apparatuses used in conjunction with the pressure sensing component 200. In some instances, the PCBA 214 may include circuitry that may be configured to format one or more output signals provided by the sensor 210 into a particular output format. For example, circuitry of the PCBA 214 may be configured to format the output signal provided by sensor 210 into a ratio-metric output format, a current format, a digital output format and/or any other suitable format. In some cases, the circuitry of the PCBA 214 may be configured to regulate an output voltage. Circuitry on the PCBA 214 for providing a ratio-metric (or other) output may include traces and/or other circuitry that may serve as a conduit to test pads, and/or for providing the ratio-metric (or other) output to one or more electrical terminals facilitating electrical connections with electronic components of one or more apparatuses used in conjunction with the pressure sensing component 200.

In some examples, the PCBA 214 may comprise a Wheatstone bridge circuit. For example, the Wheatstone bridge circuit may supply a small amount of current to the sensor 210. In response to an amount of media pressure applied, the resistivity of a plurality of strain gauges of the example sensor 210 may change in proportion to the pressure applied such that less current passes through the sensor 210. Accordingly, a measurable detected electric current may be utilized to generate a measurable output or pressure signal.

While FIG. 2 provides a example pressure sensing component, it is noted that the scope of the present disclosure is not limited to such embodiments. In various embodiments, the example pressure sensing component in accordance with the present disclosure may be in other forms.

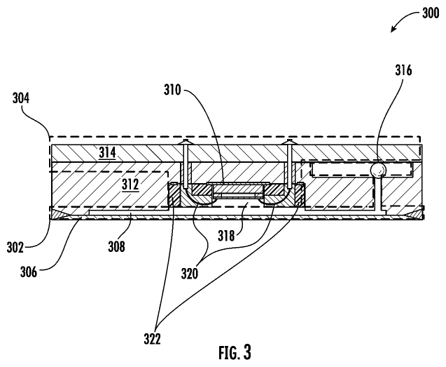

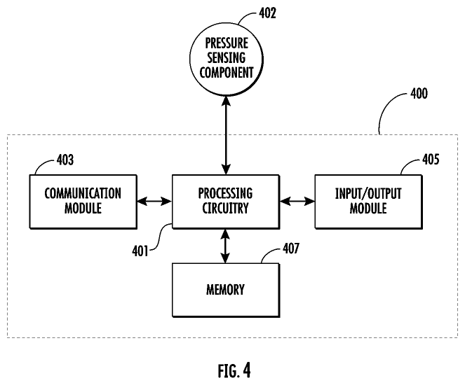

Referring now to FIG. 3, a cross-section of another example pressure sensing component 300 in accordance with various embodiments of the present disclosure is depicted. In particular, the example pressure sensing component 300 comprises a pressure sensing element 302 configured to detect a pressure of a media and a pressure measuring element 304 configured to provide a measurable electrical signal in response to the media pressure detected and/or absorbed by the pressure sensing element 302. As depicted, the pressure sensing component 300 comprises a substantially planar, circular unitary body. In various embodiments, as depicted, the example pressure sensing component 300 comprises a pressure sensing element 302 and a pressure measuring element 204 with an inner substrate 312 disposed therebetween. In some examples, the pressure sensing component may have a diameter of 10 mm and a thickness dimension of 5 mm.

As depicted in FIG. 3, the pressure sensing element 302 comprises a outer substrate 306 defining a bottom surface of the pressure sensing component 300 configured to absorb a pressure of a media and an inner surface defining a microfluidic channel 308. As depicted, the outer substrate 306 comprises a diaphragm, membrane and/or the like configured to absorb the pressure of the media. In some examples, the outer substrate 306 may be configured to deform in response to the pressure of the media. As depicted, the outer substrate 306 comprises a substantially planar, circular shape. In some examples, the outer substrate 306 may be or comprise stainless steel or other suitable material. By way of example, the diameter of the outer substrate 306 may be between 8 mm and 10 mm and the thickness dimension of the outer substrate 306 may be between 0.025 mm and 0.050 mm. As depicted in FIG. 3, the outer substrate 306 may be fixedly attached (e.g., welded) to a surface of the pressure sensing component 300, such as to another substrate or layer of the pressure sensing component 300. As depicted, the in FIG. 2, an inner surface of the outer substrate 306 is fixedly attached or welded to a surface of an inner substrate 312.

As depicted, in FIG. 3, the pressure sensing element 202 comprises an inner substrate 312 disposed in between the outer substrate 206 and the pressure measuring element 304. The diameter of the example inner substrate 312 may be approximately 10 mm and the thickness dimension of the example inner substrate may be approximately 4 mm. In some examples, the inner substrate 312 may comprise a header (e.g., Kovar header) disposed in between the pressure sensing element 302 and the pressure measuring element 304. The diameter of the example inner substrate 312 may be approximately 10 mm and the thickness dimension of the example inner substrate 312 may be approximately 4 mm. For example, the inner substrate 312 may comprise a header (e.g., Kovar header). As depicted, the inner substrate 312 and the outer substrate 306 may be fixedly attached (e.g., welded) to one another. In some examples, the inner substrate 312 may be made from other materials such as stainless steel. Additionally, as depicted, the inner substrate 312 comprises a concentrically located cavity oriented above the microfluidic channel 308 within which at least a portion of the pressure measuring element 304 is fixedly attached.

As depicted in FIG. 3, the pressure sensing element 302 comprises a microfluidic channel 308. The microfluidic channel 308 may be or comprise a sealed cavity or channel containing a pressure transfer fluid configured to transfer a pressure applied to the bottom surface of the outer substrate 306 such that it can be detected and measured by the pressure measuring element 304. In some examples, the example microfluidic channel 308 may be mechanically and/or or hermetically sealed. By way of example, the microfluidic channel 308 may define a sealed cavity having a depth between 50-60 microns and containing a pressure transfer fluid therein. In some examples, the volume of the pressure transfer fluid within the microfluidic channel 308 may be between 6 mm³ and 18 mm³. For example, the volume of the pressure transfer fluid within the microfluidic channel 208 may be between 6 mm³ and 18 mm³. The microfluidic channel 308 may be sealed using one or more balls, screw or other materials and techniques. As depicted, the microfluidic channel 308 may be sealed using a ball 316 to close a first end of the microfluidic channel 308. In some examples, a screw or other element may be used to seal an end of the microfluidic channel 208. As noted above, in various embodiments, the microfluidic channel 308 may contain a pressure transfer fluid (e.g., silicon oil, olive oil, food-grade oil, light oil and/or the like). In response to a pressure applied to and absorbed by the outer substrate 206, the example pressure transfer fluid within the microfluidic channel 308 may be transported within the microfluidic channel 308. In some examples, in response to the pressure applied to the outer substrate 306, the fluid within the microfluidic channel may move from a first portion 308A of the microfluidic channel 308 to a second portion 308B of the microfluidic channel 308.

As noted above, the example pressure sensing component 300 comprises a pressure measuring element 304 configured to provide a measurable electrical signal in response to the media pressure detected by the pressure sensing element 302. As depicted, the pressure measuring element 304 comprises a PCBA 314 and a sensor 310. The PCBA 314 may be in electronic communication with the sensor 310 such that they can exchange data/information with one another.

In some examples, the sensor 310 may be disposed within the inner substrate 312 such that the sensor 310 is able to detect a pressure transferred from an outer surface of the outer substrate 306 to the microfluidic channel 308. In some examples, as shown, the sensor 310 is completely disposed within the inner substrate 312 and oriented above the microfluidic channel 308 with a gap 318 therebetween. As depicted, the gap 318 between the sensor 310 and the microfluidic channel 308 defines a channel between the sensor 310 and the microfluidic channel 308. By way of example, the sensor 310 may be a silicon die immersed in silicone oil mounted on a surface of the inner substrate 312 (e.g., Kovar header). As depicted, the example sensor 310 may be partially isolated from the inner substrate 312 using plastic spacers 322. The example sensor 310 (e.g., silicon die) may comprise a plurality of strain gauges in electronic communication with the PCBA 314. The sensor 310 may be electrically connected to the PCBA 314 using various techniques. In some examples, wire bonds 320 may be utilized to electrically connect the sensor 210 to the PCBA 314. As depicted, wire bonds 320 disposed within the inner substrate 312 connect the sensor 310 to the PCBA 314. In some examples, the sensor 310 may be isolated from the substrate 312 using an adhesive (e.g., an attach adhesive). The adhesive may operate as an insulation material between the sensor 310 and the inner substrate 312.

As noted above, as depicted in FIG. 3, the pressure measuring element 304 comprises a PCBA 314 defining an upper surface of the sensing component 300. The example PCBA 314 may comprise a thick film printed ceramic board, an FR 4 laminate and/or other material. The example PCBA 314 may comprise one or more electronic components thereon and/or pads for connecting to other electronic components of an apparatus in which the pressure sensing component 300 may be housed or with which the pressure sensing component 300 may be used. In some examples, the PCBA 314 may include an application specific integrated circuit (ASIC) that may be attached to a surface of the PCBA 314, such as an ASIC electrically coupled to the PCBA 314 via wire bonds, bump bonds, electrical terminals, and/or any other suitable electrical connections. Additionally or alternatively, the example PCBA 314 may include one or more conductive pads for engaging circuitry and/or electronic components in communication with a remote processor or the like.

Additionally and/or alternatively, the PCBA 314 may comprise one or more processing electronics and/or compensation circuitry (e.g., which may or may not include an ASIC). Such processing electronics may be electrically connected to terminals of the sensor 310, an ASIC (if present), and/or electrical terminals to process electrical signals from the sensor 310 and/or to transfer outputs from the sensor 310 to electronic components of one or more apparatuses used in conjunction with the pressure sensing component 300. In some instances, the PCBA 314 may include circuitry that may be configured to format one or more output signals provided by the sensor 310 into a particular output format. For example, circuitry of the PCBA 314 may be configured to format the output signal provided by sensor 310 into a ratio-metric output format, a current format, a digital output format and/or any other suitable format. In some cases, the circuitry of the PCBA 314 may be configured to regulate an output voltage. Circuitry on the PCBA 314 for providing a ratio-metric (or other) output may include traces and/or other circuitry that may serve as a conduit to test pads, and/or for providing the ratio-metric (or other) output to one or more electrical terminals facilitating electrical connections with electronic components of one or more apparatuses used in conjunction with the pressure sensing component 300.

In some examples, the PCBA 314 may comprise a Wheatstone bridge circuit. For example, the Wheatstone bridge may supply a small amount of current to the sensor 310. In response to an amount of media pressure applied, the resistivity of the plurality of strain gauges may change in proportion to the pressure applied such that less current passes through the sensor 310. Accordingly, a measurable detected electric current may be utilized to generate a readable pressure signal.

While some of the embodiments herein provide example pressure sensing components, it is noted that the scope of the present disclosure is not limited to such embodiments. In various embodiments, the example pressure sensing component in accordance with the present disclosure may be in other forms. Additionally and/or alternatively, other types of sensing elements and/or components (e.g., wet sensing elements and/or oil-based sensing elements) may be provided in accordance with the present disclosure.

Referring now to FIG. 4, a schematic diagram depicting an example controller component 400 of an example apparatus in electronic communication with a pressure sensing component 402 in accordance with various embodiments of the present disclosure is provided. The example apparatus may be or comprise, for example, without limitation, a motor control apparatuses, hydraulic control apparatus, blood diffusion apparatus, control system apparatus and the like. As shown, the controller component 400 comprises processing circuitry 401, a communication module 403, input/output module 405, a memory 407 and/or other components configured to perform various operations, procedures, functions or the like described herein.

As shown, the controller component 400 (such as the processing circuitry 401, communication module 403, input/output module 405 and memory 407) is electrically coupled to and/or in electronic communication with a pressure sensing component 402 such that it can exchange (e.g., transmit and receive) data with the processing circuitry 401 of the controller component 400. In some embodiments, the pressure sensing component 402 may be coupled to the controller component 400. In other embodiments, the pressure sensing component 402 may be remote from the controller component 400.

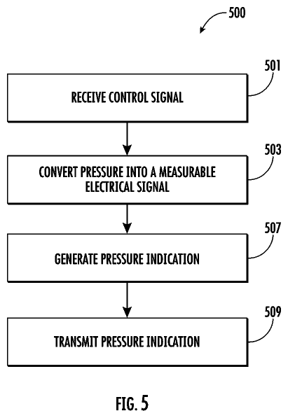

The processing circuitry 401 may be implemented as, for example, various devices comprising one or a plurality of microprocessors with accompanying digital signal processors; one or a plurality of processors without accompanying digital signal processors; one or a plurality of coprocessors; one or a plurality of multi-core processors; one or a plurality of controllers; processing circuits; one or a plurality of computers; and various other processing elements (including integrated circuits, such as ASICs or FPGAs, or a certain combination thereof). In some embodiments, the processing circuitry 401 may comprise one or more processors. In one exemplary embodiment, the processing circuitry 401 is configured to execute instructions stored in the memory 407 or otherwise accessible by the processing circuitry 401. When executed by the processing circuitry 401, these instructions may enable the controller component 400 to execute one or a plurality of the functions as described herein. No matter whether it is configured by hardware, firmware/software methods, or a combination thereof, the processing circuitry 401 may comprise entities capable of executing operations according to the embodiments of the present invention when correspondingly configured. Therefore, for example, when the processing circuitry 401 is implemented as an ASIC, an FPGA, or the like, the processing circuitry 401 may comprise specially configured hardware for implementing one or a plurality of operations described herein. Alternatively, as another example, when the processing circuitry 401 is implemented as an actuator of instructions (such as those that may be stored in the memory 407), the instructions may specifically configure the processing circuitry 401 to execute one or a plurality of algorithms and operations described herein, such as those discussed with reference to FIG. 5.

The memory 407 may comprise, for example, a volatile memory, a non-volatile memory, or a certain combination thereof. Although illustrated as a single memory in FIG. 4, the memory 407 may comprise a plurality of memory components. In various embodiments, the memory 407 may comprise, for example, a hard disk drive, a random access memory, a cache memory, a flash memory, a Compact Disc Read-Only Memory (CD-ROM), a Digital Versatile Disk Read-Only Memory (DVD-ROM), an optical disk, a circuit configured to store information, or a certain combination thereof. The memory 407 may be configured to store information, data, application programs, instructions, and etc., so that the controller component 400 can execute various functions according to the embodiments of the present disclosure. For example, in at least some embodiments, the memory 407 is configured to cache input data for processing by the processing circuitry 401. Additionally or alternatively, in at least some embodiments, the memory 407 is configured to store program instructions for execution by the processing circuitry 401. The memory 407 may store information in the form of static and/or dynamic information. When the functions are executed, the stored information may be stored and/or used by the controller component 400.

The communication module 403 may be implemented as any apparatus included in a circuit, hardware, a computer program product or a combination thereof, which is configured to receive and/or transmit data from/to another component or apparatus. The computer program product comprises computer-readable program instructions stored on a computer-readable medium (for example, the memory 407) and executed by a controller component 400 (for example, the processing circuitry 401). In some embodiments, the communication module 403 (as with other components discussed herein) may be at least partially implemented as the processing circuitry 401 or otherwise controlled by the processing circuitry 401. In this regard, the communication module 403 may communicate with the processing circuitry 401, for example, through a bus. The communication module 403 may comprise, for example, antennas, transmitters, receivers, transceivers, network interface cards and/or supporting hardware and/or firmware/software, and is used for establishing communication with another apparatus. The communication module 403 may be configured to receive and/or transmit any data that may be stored by the memory 407 by using any protocol that can be used for communication between apparatuses. The communication module 403 may additionally or alternatively communicate with the memory 407, the input/output module 405 and/or any other component of the controller component 400, for example, through a bus.

In some embodiments, the controller component 400 may comprise an input/output module 405. The input/output module 405 may communicate with the processing circuitry 401 to receive instructions input by a user and/or to provide audible, visual, mechanical or other outputs to the user. Therefore, the input/output module 405 may comprise supporting devices, such as a keyboard, a mouse, a display, a touch screen display, and/or other input/output mechanisms. Alternatively, at least some aspects of the input/output module 405 may be implemented on a device used by the user to communicate with the controller component 400. The input/output module 405 may communicate with the memory 407, the communication module 403 and/or any other component, for example, through a bus. One or a plurality of input/output modules and/or other components may be included in the controller component 400.

For example, the pressure sensing component 402 may be similar to pressure sensing component 200 described above with regard to FIG. 2. In another example, the pressure sensing component 402 may be similar to pressure sensing component 300 described above with regard to FIG. 3. For example, pressure sensing component 402 may convert a pressure of a media absorbed by the pressure sensing component 402 into a measurable electrical signal.

Referring now to FIG. 5, a flowchart diagram illustrating example operations 500 in accordance with various embodiments of the present disclosure is provided.

In some examples, the method 500 may be performed by a pressure sensing component (such as, but not limited to, pressure sensing component 402 described above with regard to FIG. 2) in electronic communication with processing circuitry (for example, but not limited to, an application-specific integrated circuit (ASIC), a central processing unit (CPU)). In some examples, the processing circuitry may be electrically coupled to and/or in electronic communication with other circuitries of an example apparatus, such as, but not limited to, a memory (such as, for example, random access memory (RAM) for storing computer program instructions), and/or a display circuitry (for rendering readings on a display).

In some examples, one or more of the procedures described in FIG. 5 may be embodied by computer program instructions, which may be stored by a memory (such as a non-transitory memory) of a system employing an embodiment of the present disclosure and executed by a processing circuitry (such as a processor) of the system. These computer program instructions may direct the system to function in a particular manner, such that the instructions stored in the memory circuitry produce an article of manufacture, the execution of which implements the function specified in the flow diagram step/operation(s). Further, the system may comprise one or more other circuitries. Various circuitries of the system may be electronically coupled between and/or among each other to transmit and/or receive energy, data and/or information.

In some examples, embodiments may take the form of a computer program product on a non-transitory computer-readable storage medium storing computer-readable program instruction (e.g., computer software). Any suitable computer-readable storage medium may be utilized, including non-transitory hard disks, CD-ROMs, flash memory, optical storage devices, or magnetic storage devices.

The example method 500 begins at step/operation 501. At step/operation 501, the pressure sensing component (such as, but not limited to pressure sensing element 202 and pressure sensing element 302 discussed above in relation to FIG. 2 and FIG. 3, respectively) receives a control signal to trigger activating the pressure sensing component. For example, the pressure sensing component may the control signal from a processing circuitry (such as, but not limited to, the processing circuitry 401 of the controller component 400 illustrated in connection with FIG. 4, discussed above).

Subsequent to step/operation 501, the method proceeds to step/operation 503. At step/operation 503, the pressure sensing component converts a detected pressure into a measurable electrical signal. For example, pressure sensing element of the pressure sensing component (such as, but not limited to pressure sensing element 202 and pressure sensing element 302 discussed above in relation to FIG. 2 and FIG. 3, respectively) may detect an incoming pressure of a media absorbed by the pressure sensing element. In particular, pressure sensing element may detect a pressure absorbed by a microfluidic channel of the pressure sensing element (such as, but not limited to microfluidic channel 208 and microfluidic channel 308 described above in connection with FIG. 2 and FIG. 3, respectively). Pressure measuring element of the pressure sensing component (such as, but not limited to pressure measuring element 204 and pressure measuring element 304 discussed above in relation to FIG. 2 and FIG. 3, respectively) may convert a measure of the pressure caused by the incoming pressure of the media into a measurable electrical signal.

Subsequent to step/operation 503, the method proceeds to step/operation 505. At step/operation 503, pressure sensing component generates a pressure indication associated with the incoming pressure of the media. In various embodiments, the pressure indication may comprise an absolute pressure, a gauge pressure, or the like.

Subsequent to step/operation 505, the method proceeds to step/operation 507. At step/operation 507, pressure sensing component transmits the pressure indication. For example, pressure sensing component transmits the pressure indication to a controller component. In turn, the controller component may provide output corresponding with the pressure indication to an end user (e.g., via the input/output module of the controller component).

Many modifications and other embodiments of the present disclosure set forth herein will come to mind to one skilled in the art to which these embodiments pertain having the benefit of the teachings presented in the foregoing descriptions and the associated drawings. Therefore, it is to be understood that the disclosure are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A pressure sensing component comprising:
a pressure sensing element defining a microfluidic channel containing a pressure transfer fluid configured to absorb a pressure of a media applied to the pressure sensing element, wherein at least one dimension of the microfluidic channel is in a micrometer range; and
a pressure measuring element in electronic communication with the pressure sensing element, wherein the pressure measuring element is configured to convert the pressure of the media absorbed by the pressure sensing element into a measurable electrical signal.

2. The pressure sensing component of claim 1, wherein the pressure measuring element is isolated from the pressure sensing element.

3. The pressure sensing component of claim 1, wherein the pressure measuring element comprises a sensor in electronic communication with a printed circuit board assembly.

4. The pressure sensing component of claim 1, wherein the pressure measuring element is further configured to:
in response to receiving a control signal, generate a pressure indication corresponding with the measurable electrical signal, and
transmit the pressure indication to a controller component in electronic communication with the pressure sensing component.

5. The pressure sensing component of claim 3, wherein the sensor comprises a sense die.

6. The pressure sensing component of claim 5, wherein a volume of pressure transfer fluid within the microfluidic channel is between 6 mm³ and 18 mm³.

7. The pressure sensing component of claim 5, wherein the pressure transfer fluid comprises silicon oil.

8. The pressure sensing component of claim 5, wherein the pressure transfer fluid comprises a food-grade oil or light oil.

9. The pressure sensing component of claim 5, wherein the microfluidic channel is hermetically sealed.

10. The pressure sensing component of claim 1, wherein the microfluidic channel defines a cavity comprising a depth between 50-60 microns.

11. A method for detecting a pressure of a media by a pressure sensing component comprising a microfluidic channel containing a pressure transfer fluid, wherein at least one dimension of the microfluidic channel is in a micrometer range, the method comprising:
absorbing, by the pressure sensing component, a pressure of a media; and
converting, by the pressure sensing component, the pressure of the media into a measurable electrical signal.

12. The method according to claim 11, wherein the pressure sensing component comprises:
a pressure sensing element defining the microfluidic channel which is configured to absorb the pressure of the media, and
a pressure measuring element in electronic communication with the pressure sensing element configured to convert the pressure of the media into the measurable electrical signal, and wherein the pressure measuring element is isolated from the pressure sensing element.

13. The method according to claim 12, wherein the pressure measuring element comprises a sensor in electronic communication with a printed circuit board assembly.

14. The method according to claim 13, further comprising:
in response to receiving a control signal, generating a pressure indication corresponding with the measurable electrical signal, and
transmitting the pressure indication to a controller component in electronic communication with the pressure sensing component.

15. The method according to claim 11, wherein the sensor comprises a sense die.

16. The method according to claim 15, wherein a volume of pressure transfer fluid within the microfluidic channel is between 6 mm³ and 18 mm³.

17. The method according to claim 15, wherein the pressure transfer fluid comprises silicon oil.

18. The method according to claim 15, wherein the pressure transfer fluid comprises a food-grade oil or light oil.

19. The method according to claim 15, wherein the microfluidic channel is hermetically sealed.

20. The method according to claim 11, wherein the microfluidic channel defines a cavity comprising a depth between 50-60 microns.
